(19) United States
(12) Patent Application Publication
(10) Pub. No.: US 2009/0007468 A1
(43) Pub. Date: Jan. 8, 2009

(54) METHOD OF TEACHING READING

(76) Inventor: Paul Michael Smith, Vancouver (CA)

Correspondence Address: CAMERON IP, SUITE 1401 - 1166 ALBERNI STREET, VANCOUVER, BC, V6E 3Z3, CA

(21) Appl. No.: 11/773,925

(22) Filed: Jul. 5, 2007

(51) Int. Cl. G09B 17/00; G09F 1/00

(52) U.S. Cl. 40/124.01; 434/178

(57) ABSTRACT

A method of teaching a student how to read comprises selecting a word to be taught, the word comprising a letter; providing the letter with a visual indicium to form a phonogram, the visual indicium symbolizing a known word having a known pronunciation; using at least a portion of the known pronunciation of the known word to guide the student on how the phonogram is pronounced; and using the pronunciation of the phonogram to guide the student on how the word to be taught is read.

### BACKGROUND OF THE INVENTION

The present invention relates to a method of teaching reading and, in particular, to associating visual indicium with sounds.

Students often experience difficulty learning to read English because of ambiguities and inconsistencies in the way words are written and sounded. As a result, numerous methods of teaching reading which employ games or pictograms to reinforce recurring spelling and sounding patterns have been developed. Although somewhat useful, these methods require that a student remember game rules, or follow storylines, which distracts from the actual spelling and sounding of words. For example, the Letterland Training Program available from Letterland International Ltd., of New Road, Barton, Cambridge, United Kingdom CB23 7AY, uses pictograms formed by the fusion of letters and animated characters. To learn why the letters c and h make a new joint sound in words like chin and church, a student taught with the Letterland Training Program must remember that Clever Cat (the letter c) belongs to Harry Hat Man (the letter h). Harry Hat Man looks after Clever Cat and Clever Cat loves Harry Hat Man. However, Clever Cat has one problem, as soon as Clever Cat finds herself next to Harry Hat Man in a word, Harry Hat Man's hairy hat makes Clever Cat's nose tickle. So whenever Clever Cat and Harry Hat Man come together in a word, all you can hear is Clever Cat's sneezing sound, “ch!”.

In view of the above-mentioned shortcomings improved methods of teaching reading employ a modified alphabet. A modified alphabet is not significantly different from the English alphabet and emphasizes the sounding of words through visual indicium. Use of a modified alphabet does not distort the spelling of a word nor does it require a student remember game rules or follow storylines. U.S. Pat. Nos. 6,077,080 and 6,604,947 to Rai disclose a method of teaching reading using a modified alphabet in which visual indicium correspond to root sounds of vowels or constants and relative sounds branching therefrom. U.S. Pat. No. 6,769,798 to Sanocki discloses a method of teaching reading using a modified alphabet in which visual indicium correspond to physiologic cues. These prior art methods of teaching reading using a modified alphabet accordingly require that a student learn or memorize an underlying set of rules associated with the visual indicium.

### SUMMARY OF THE INVENTION

According to a first aspect of the invention, there is provided a method of teaching a student how to read. The method comprises selecting a word to be taught, the word comprising a letter; providing the letter with a visual indicium to form a phonogram, the visual indicium symbolizing a known word having a known pronunciation; using at least a portion of the known pronunciation of the known word to guide the student on how the phonogram is pronounced; and using the pronunciation of the phonogram to guide the student on how the word to be taught is read.

According to a second aspect of the invention, there is a method of teaching a student an alphabet. The method comprises selecting a letter to be taught; providing the letter with a visual indicium to form a phonogram, the visual indicium symbolizing a known word having a known pronunciation; using at least a portion of the known pronunciation of the known word to guide the student on how the phonogram is pronounced; and using the pronunciation of the phonogram to teach the student the letter to be taught.

According to a third aspect of the invention, there is provided a printed document comprising a word including a phonogram. The phonogram includes a letter and a visual indicium. The visual indicium symbolizes a known word having a known pronunciation. At least a portion of the known pronunciation of the known word guides how the phonogram is pronounced. The pronunciation of the phonogram guides how the word is read.

### BRIEF DESCRIPTION OF THE DRAWING

In the drawings:

FIG. 1 is a table illustrating exemplar phonograms, comprising a single alphabet letter, which are used practice the present invention;

FIG. 2 is a table illustrating exemplar phonograms, comprising an alphabet letter group, which are used practice the present invention;

FIG. 3 illustrates the word “had”, depicted in phonograms, as used to practice the present invention;

FIG. 4 illustrates the word “and”, depicted in phonograms, as used to practice the present invention;

FIG. 5 illustrates the word “goes”, depicted in phonograms, as used to practice the present invention;

FIG. 6 illustrates a first embodiment of the word “cough”, depicted in phonograms, as used to practice the present invention;

FIG. 7 illustrates a second embodiment of the word “cough”, depicted in phonograms and letters, as used to practice the present invention; and

FIG. 8 illustrates the word “large”, depicted in phonograms, as used to practice the present invention.

### DETAILED DESCRIPTION OF THE PREFERRED EMBODIMENT

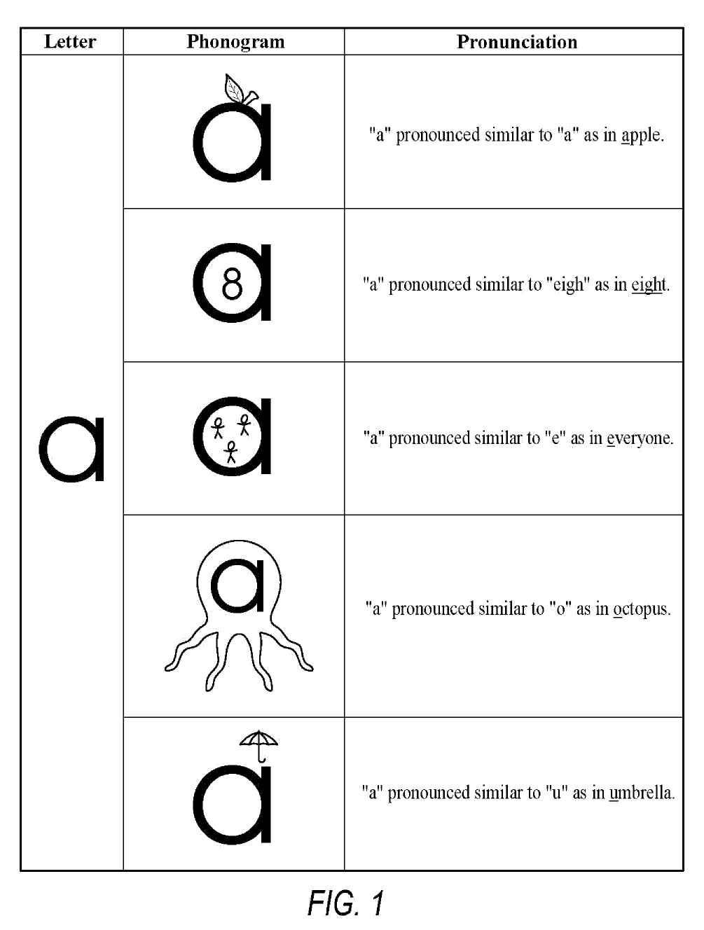

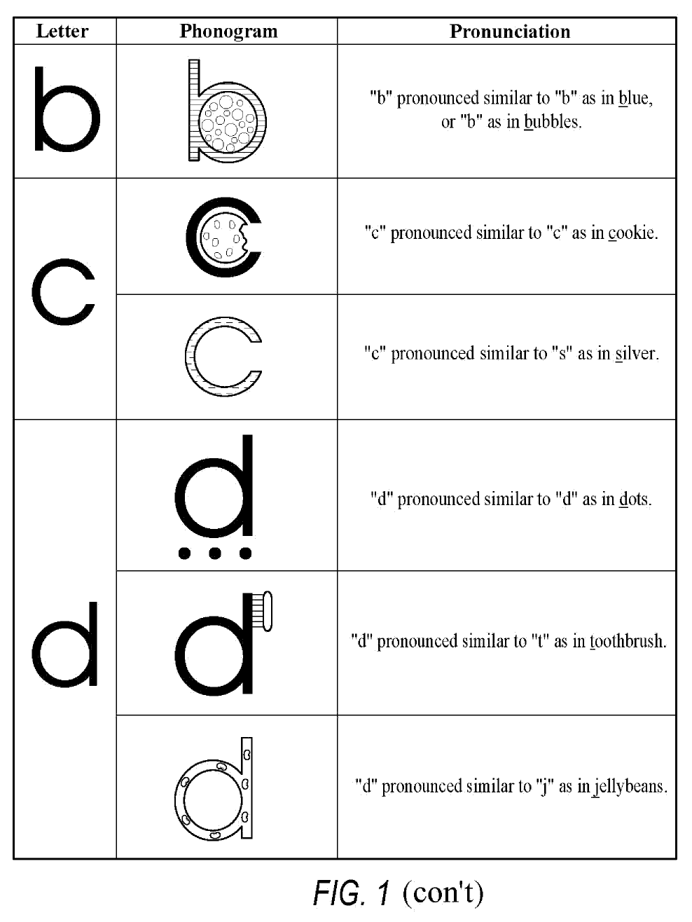

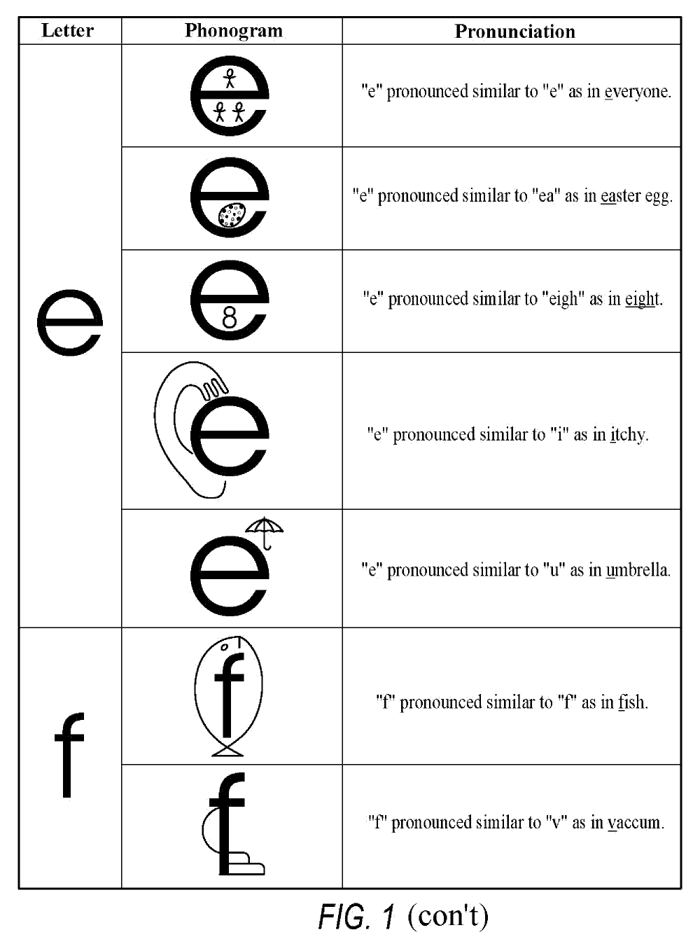

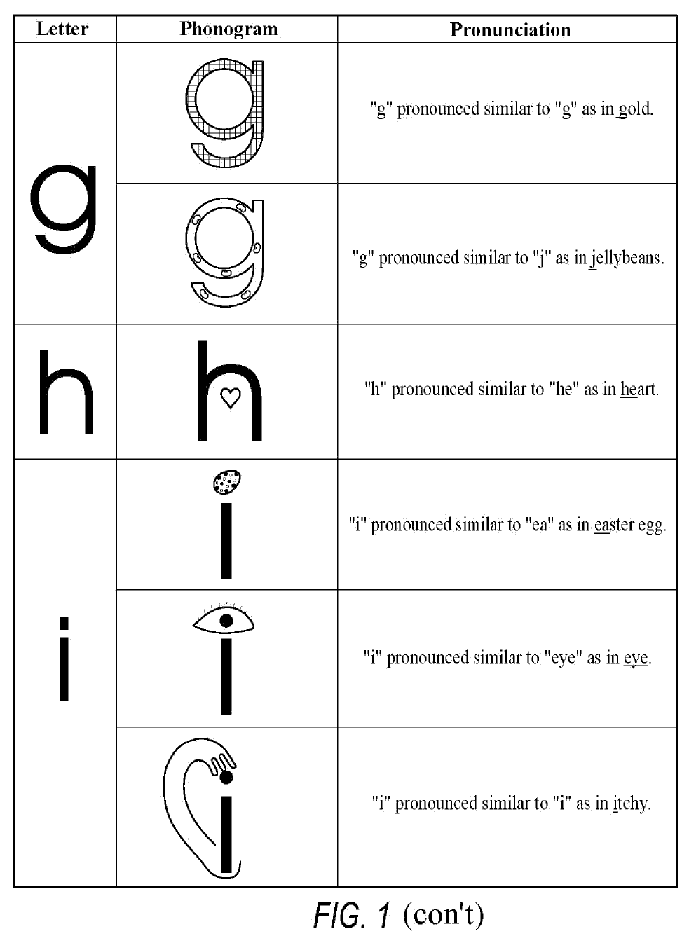

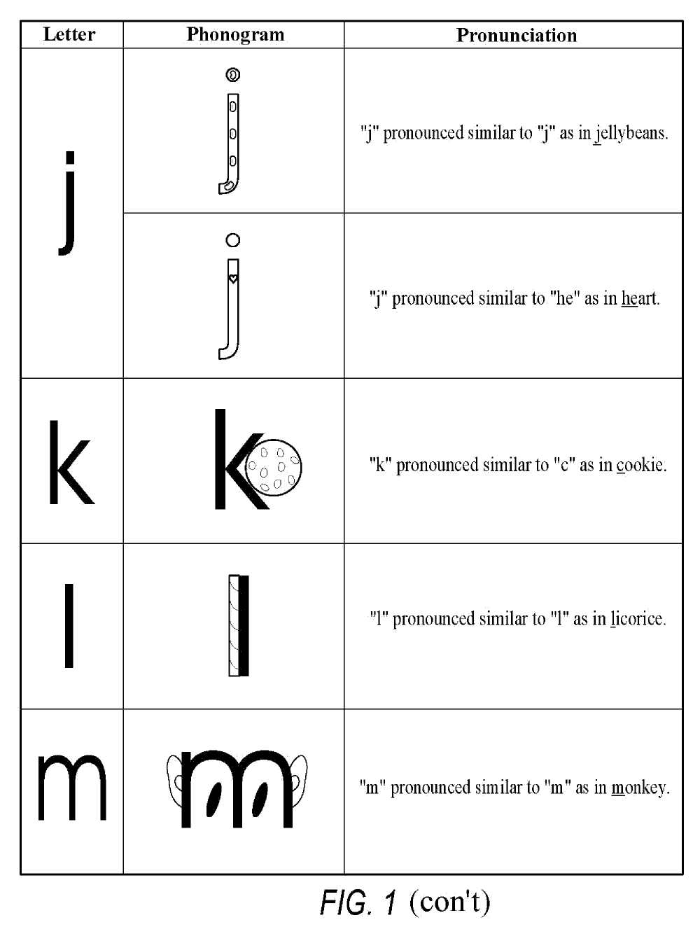

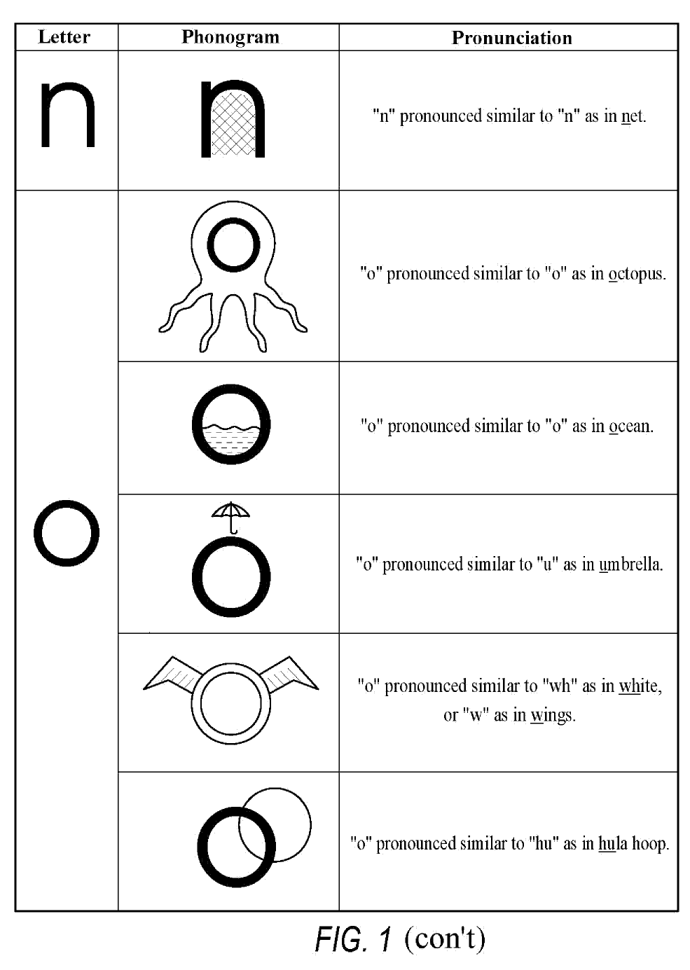

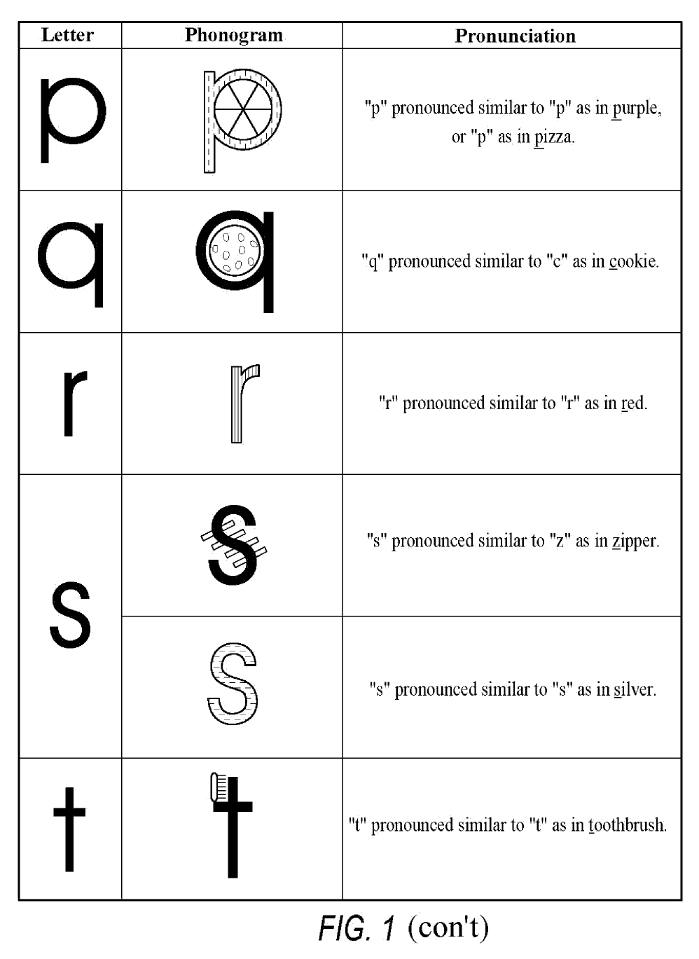

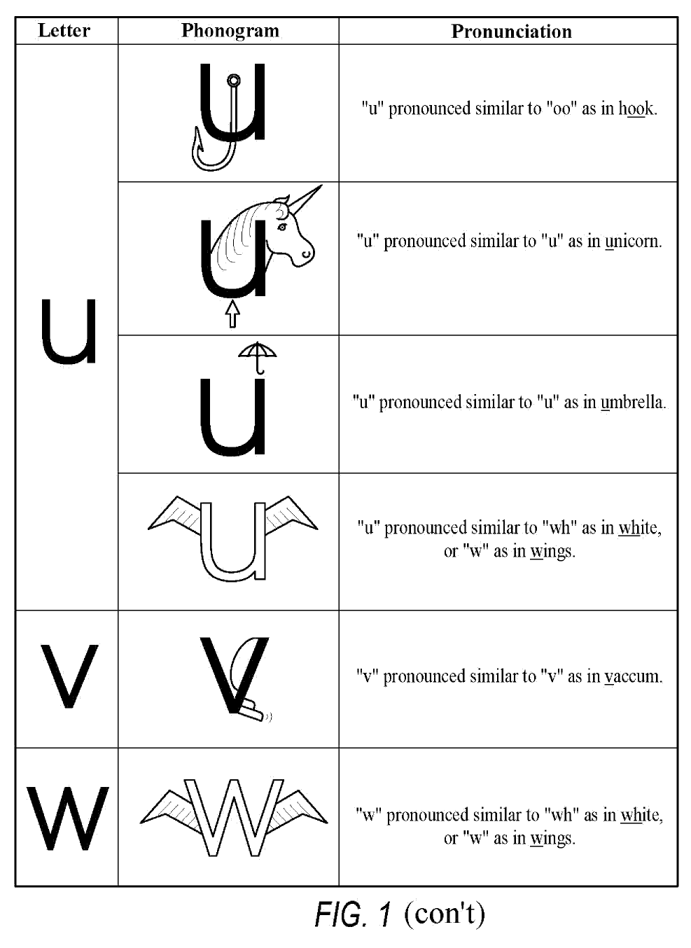

As shown in FIG. 1, for the English language, alphabet letters are provided with visual indicium to create a modified alphabet comprised of phonograms. The visual indicium each symbolize a known word having a known pronunciation. The known word symbolized by each visual indicium is readily discernable from the appearance of said visual indicium. In one example, the visual indicium may be the color of the letter. In this case the known word is the name of the color. In another example, the visual indicium may be a drawing in the form of an object. In this case the known word is the name of the object. In still another example, a fusion of the visual indicium and the letter may be a drawing in the form of an object. In this case the known word is the name of the object.

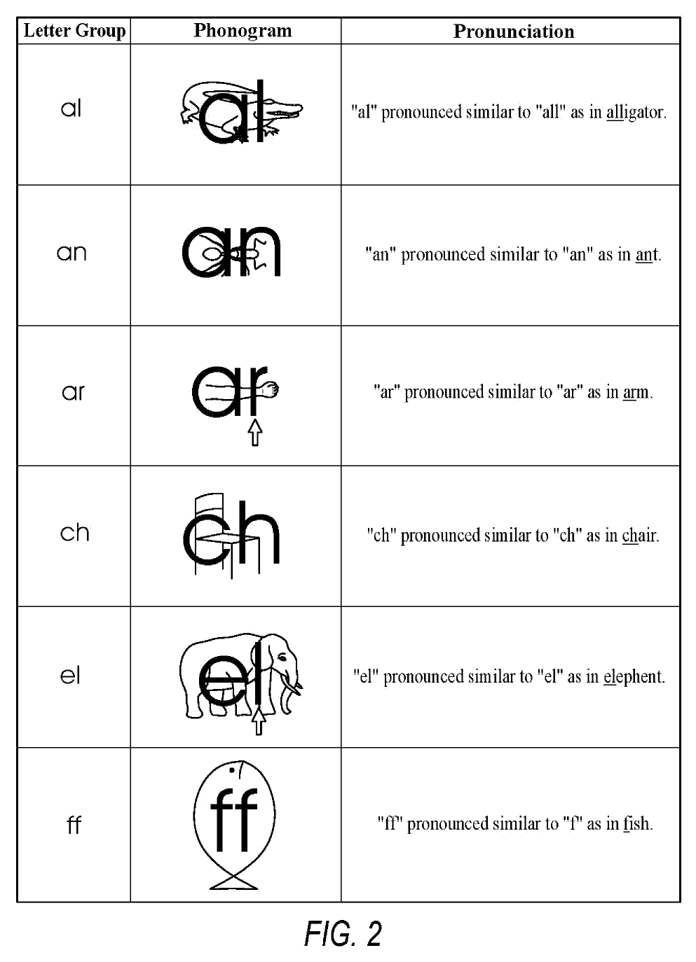

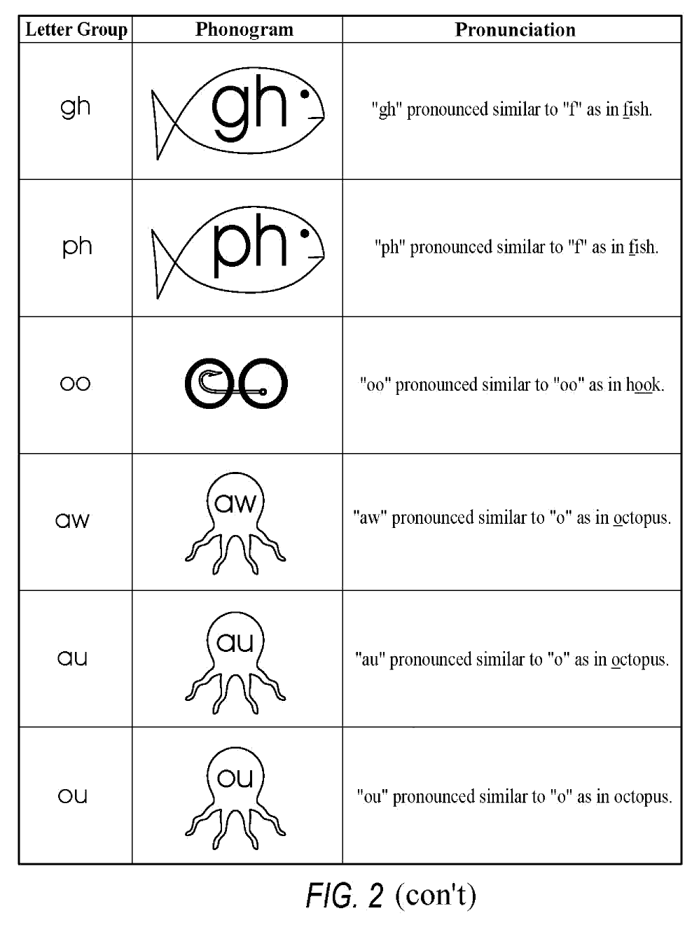

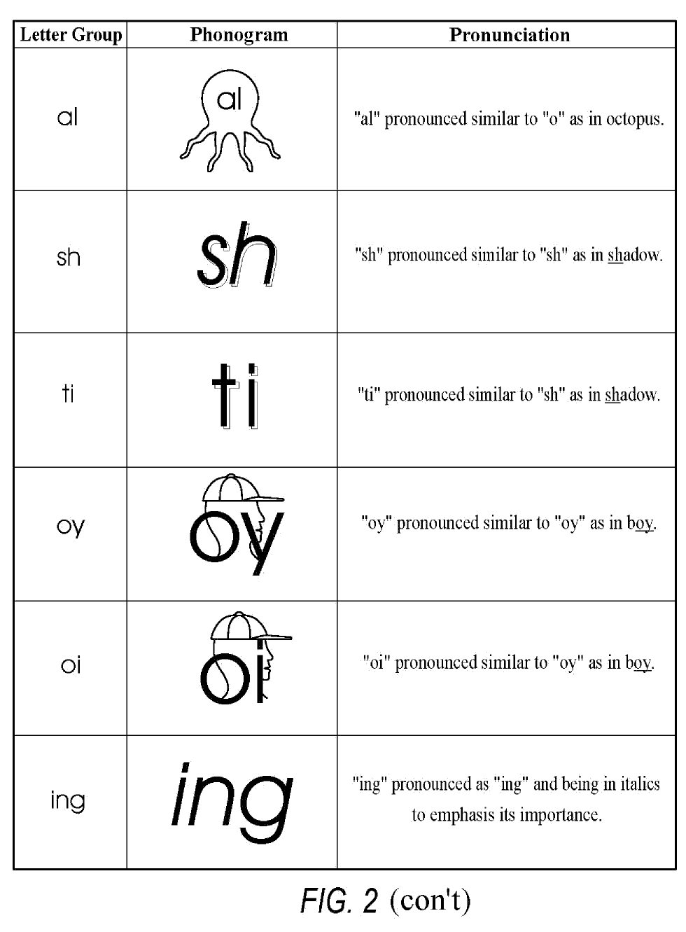

As shown in FIG. 2, for the English language, alphabet letter groups may also be provided with visual indicium to create phonograms to supplement the modified alphabet shown in FIG. 1. The visual indicium each symbolize a known word having a known pronunciation. The known word symbolized by each visual indicium is readily discernable from the appearance of said visual indicium. The visual indicium also provide a visual link between the letters in the letter group. In one example, the visual indicium may be the color of the letters. In this case the known word is the name of the color. In another example, the visual indicium may be a drawing in the form of an object. In this case the known word is the name of the object. In still another example, a fusion of the visual indicium and the letters may be a drawing in the form of an object. In this case the known word is the name of the object.

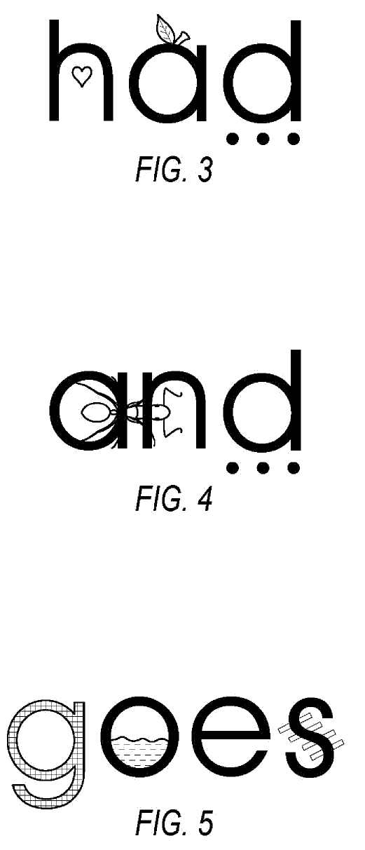

Phonograms, such as those shown in FIGS. 1 and 2, are used to depict words as shown in the examples provided in FIGS. 3 to 8. Each depicted word is read based on the pronunciation of the phonograms comprising the word. The pronunciation of each phonogram is based, at least in part, on the pronunciation of the known word symbolized by the visual indicium comprised in the phonogram. Since the known word symbolized by the visual indicium comprised in the phonogram is readily discernable from the appearance of the visual indicium, there is no need for a student to learn an underlying set of pronunciation rules. Furthermore, since the alphabet letters are the dominant feature of each phonogram, as the student progresses, the visual indicia may be gradually removed until the word is depicted in alphabet letters only, i.e. in a regular font.

As shown in FIG. 1, the letter “a” may be provided with at least five different visual indicium. In a first example, the letter “a” is provided with a visual indicum in the form of a drawing of an apple stem and leaf to form a first embodiment of a phonogram comprising the letter “a”. In this embodiment, the letter “a” and the drawing of the apple stem and leaf fuse to form a drawing of an apple. The drawing symbolizes the known word “apple”. The use of the known pronunciation of the word “apple” directly guides how the first embodiment of the phonogram comprising the letter “a” is pronounced. More particularly, the first embodiment of the phonogram comprising the letter “a” is pronounced similar to the letter “a” as in apple. The first embodiment of the phonogram comprising the letter “a” may therefore be used to depict the letter “a” in the word “after” as the letter “a” in the word “after” is pronounced in a similar manner to the letter “a” in the word “apple”.

In a second example, the letter “a” is provided with a visual indicium in the form of a drawing of the numeral eight to form a second embodiment of a phonogram comprising the letter “a”. The drawing symbolizes the known word “eight”. The use of the known pronunciation of the word “eight” directly guides how the second embodiment of the phonogram comprising the letter “a” is pronounced. More particularly, the second embodiment of the phonogram comprising the letter “a” is pronounced similar to the letters “eigh” as in eight. The second embodiment of the phonogram comprising the letter “a” may therefore be used to depict the letter “a” in the word “cake” as the letter “a” in the word “cake” is pronounced in a similar manner to the letters “eigh” in the word “eight”.

In a third example, the letter “a” is provided with a visual indicium in the form of a drawing of several people to form a third embodiment of a phonogram comprising the letter “a”. The drawing symbolizes the known word “everyone”. The use of the known pronunciation of the word “everyone” directly guides how the third embodiment of the phonogram comprising the letter “a” is pronounced. More particularly, the third embodiment of the phonogram comprising the letter “a” is pronounced similar to the letter “e” as in everyone. The third embodiment of the phonogram comprising the letter “a” may therefore be used to depict the letter “a” in the word “said” as the letter “a” in the word “said” is pronounced in a similar manner to the letter “e” in the word “everyone”.

In a fourth example, the letter “a” is provided with a visual indicium in the form of a drawing of an octopus to form a fourth embodiment of a phonogram comprising the letter “a”. The drawing symbolizes the known word “octopus”. The use of the known pronunciation of the word “octopus” directly guides how the fourth embodiment of the phonogram comprising the letter “a” is pronounced. More particularly, the fourth embodiment of the phonogram comprising the letter “a” is pronounced similar to the letter “o” as in octopus. The fourth embodiment of the phonogram comprising the letter “a” may therefore be used to depict the letter “a” in the word “ball” as the letter “a” in the word “ball” is pronounced in a similar manner to the letter “o” in the word “octopus”.

In a fifth example, the letter “a” is provided with a visual indicium in the form of a drawing of an umbrella to form a fifth embodiment of a phonogram comprising the letter “a”. The drawing symbolizes the known word “umbrella”. The use of the known pronunciation of the word “umbrella” directly guides how the fifth embodiment of the phonogram comprising the letter “a” is pronounced. More particularly, the fifth embodiment of the phonogram comprising the letter “a” is pronounced similar to the letter “u” as in umbrella. The fifth embodiment of the phonogram comprising the letter “a” may therefore be used to depict the letter “a” in the word “about” as the letter “a” in the word “about” is pronounced in a similar manner to the letter “u” in the word “umbrella”.

The letter “b” may be simultaneously provided with at least two visual indicium to form a phonogram comprising the letter “b”. The first visual indicium provided on the letter “b” is the color of the letter “b” itself, namely blue. The color of the letter “b” symbolizes known word “blue”. The second visual indicium provided on the letter “b” is a drawing in the form of bubbles. The drawing symbolizes the known word “bubbles”. The use of the known pronunciation of the words “blue” and “bubbles” directly guides how the phonogram comprising the letter “b” is pronounced. The phonogram comprising the letter “b” is pronounced similar to the letter “b” as in blue or the letter “b” as in bubbles. The phonogram comprising the letter “b” may therefore be used to depict the letter “b” in the word “big” as the letter “b” in the word “about” is pronounced in a similar manner to the letter “b” as in blue or the letter “b” as in bubbles. The use of more than one visual indicium re-enforces the pronunciation of the phonogram comprising the letter “b” by providing more than one known word to guide pronunciation of the phonogram.

The letter “c” may be provided with at least two different visual indicium. In a first example, the letter “c” is provided with a visual indicium in the form of a drawing of a cookie to form a first embodiment of a phonogram comprising the letter “c”. The drawing symbolizes the known word “cookie”. The use of the known pronunciation of the word “cookie” directly guides how the first embodiment of the phonogram comprising the letter “c” is pronounced. More particularly, the first embodiment of the phonogram comprising the letter “c” is pronounced similar to the letter “c” as in cookie. The first embodiment of the phonogram comprising the letter “c” may therefore be used to depict the letter “c” in the word “cat” as the letter “c” in the word “cat” is pronounced in a similar manner to the letter “c” in the word “cookie”.

In a second example, the letter “c” is provided with a visual indicium in the form of color of the letter “c” itself, namely silver, to form a second embodiment of a phonogram comprising the letter “c”. The color of the letter “c” symbolizes the known word “silver”. The use of the known pronunciation of the word “silver” directly guides how the second embodiment of the phonogram comprising the letter “c” is pronounced. More particularly, the second embodiment of the phonogram comprising the letter “c” is pronounced similar to the letter “s” as in silver. The second embodiment of the phonogram comprising the letter “c” may therefore be used to depict the letter “c” in the word “city” as the letter “c” in the word “city” is pronounced in a similar manner to the letter “s” in the word “silver”.

The letter “d” may be provided with at least three different visual indicium. In a first example, the letter “d” is provided with a visual indicium in the form of a drawing of dots to form a first embodiment of a phonogram comprising the letter “d”. The drawing symbolizes the known word “dots”. The use of the known pronunciation of the word “dots” directly guides how the first embodiment of the phonogram comprising the letter “d” is pronounced. More particularly, the first embodiment of the phonogram comprising the letter “d” is pronounced similar to the letter “d” as in dots. The first embodiment of the phonogram comprising the letter “d” may therefore be used to depict the letter “d” in the word “dog” as the letter “d” in the word “dog” is pronounced in a similar manner to the letter “d” in the word “dots”.

In a second example, the letter “d” is provided with a visual indicium in the form of a drawing of a toothbrush to form a second embodiment of a phonogram comprising the letter “d”. The drawing symbolizes the known word “toothbrush”. The use of the known pronunciation of the word “toothbrush” directly guides how the second embodiment of the phonogram comprising the letter “d” is pronounced. More particularly, the second embodiment of the phonogram comprising the letter “d” is pronounced similar to the letter “t” as in toothbrush. The second embodiment of the phonogram comprising the letter “d” may therefore be used to depict the letter “d” in the word “pushed” as the letter “d” in the word “pushed” is pronounced in a similar manner to the letter “t” in the word “toothbrush”.

In a third example, the letter “d” is provided with a visual indicium in the form of a drawing of jellybeans to form a third embodiment of a phonogram comprising the letter “d”. The drawing symbolizes the known word “jellybeans”. The use of the known pronunciation of the word “jellybeans” directly guides how the third embodiment of the phonogram comprising the letter “d” is pronounced. More particularly, the third embodiment of the phonogram comprising the letter “d” is pronounced similar to the letter “j” as in jellybeans. The third embodiment of the phonogram comprising the letter “d” may therefore be used to depict the letter “d” in the word “dress” as the letter “d” in the word “dress” is pronounced in a similar manner to the letter “j” in the word “jellybeans”.

The letter “e” may be provided with at least five different visual indicium. In a first example, the letter “e” is provided with a visual indicium in the form of a drawing of several people to form a first embodiment of a phonogram comprising the letter “e”. The drawing symbolizes the known word “everyone”. The use of the known pronunciation of the word “everyone” directly guides how the first embodiment of the phonogram comprising the letter “e” is pronounced. More particularly, the first embodiment of the phonogram comprising the letter “e” is pronounced similar to the letter “e” as in everyone. The first embodiment of the phonogram comprising the letter “e” may therefore be used to depict the letter “e” in the word “get” as the letter “e” in the word “get” is pronounced in a similar manner to the letter “e” in the word “everyone”.

In a second example, the letter “e” is provided with a visual indicium in the form of a drawing of an Easter egg to form a second embodiment of a phonogram comprising the letter “e”. The drawing symbolizes the known word “Easter egg”. The use of the known pronunciation of the word “Easter egg” directly guides how the second embodiment of the phonogram comprising the letter “e” is pronounced. More particularly, the second embodiment of the phonogram comprising the letter “e” is pronounced similar to the letters “ea” as in Easter egg. The second embodiment of the phonogram comprising the letter “e” may therefore be used to depict the letter “e” in the word “me” as the letter “e” in the word “me” is pronounced in a similar manner to the letters “ea” in word “Easter egg”.

In a third example, the letter “e” is provided with a visual indicium in the form of a drawing of the numeral eight to form a third embodiment of a phonogram comprising the letter “e”. The drawing symbolizes the known word “eight”. The use of the known pronunciation of the word “eight” directly guides how the third embodiment of the phonogram comprising the letter “e” is pronounced. More particularly, the third embodiment of the phonogram comprising the letter “e” is pronounced similar to the letters “eigh” as in eight. The third embodiment of the phonogram comprising the letter “e” may therefore be used to depict the letter “e” in the word “leg” as the letter “e” in the word “cake” is pronounced in a similar manner to the letters “eigh” in the word “eight”.

In a fourth example, the letter “e” is provided with a visual indicium in the form of a drawing of a scratching hand to form a fourth embodiment of a phonogram comprising the letter “e”. The drawing symbolizes the known word “itchy”. The use of the known pronunciation of the word “itchy” directly guides how the fourth embodiment of the phonogram comprising the letter “e” is pronounced. More particularly, the fourth embodiment of the phonogram comprising the letter “e” is pronounced similar to the letter “i” as in itchy. The fourth embodiment of the phonogram comprising the letter “e” may therefore be used to depict the letter “e” in the word “pretty” as the letter “e” in the word “pretty” is pronounced in a similar manner to the letter “i” in the word “itchy”.

In a fifth example, the letter “e” is provided with a visual indicium in the form of a drawing of an umbrella to form a fifth embodiment of a phonogram comprising the letter “e”. The drawing symbolizes the known word “umbrella”. The use of the known pronunciation of the word “umbrella” directly guides how the fifth embodiment of the phonogram comprising the letter “e” is pronounced. More particularly, the fifth embodiment of the phonogram comprising the letter “e” is pronounced similar to the letter “u” as in umbrella. The fifth embodiment of the phonogram comprising the letter “a” may therefore be used to depict the letter “e” in the word “the” as the letter “e” in the word “the” is pronounced in a similar manner to the letter “u” in the word “umbrella”.

The letter “f” may be provided with at least two different visual indicium. In a first example, the letter “f” is provided with a visual indicium in the form of a drawing of a fish to form a first embodiment of a phonogram comprising the letter “f”. The drawing symbolizes the known word “fish”. The use of the known pronunciation of the word “fish” directly guides how the first embodiment of the phonogram comprising the letter “f” is pronounced. More particularly, the first embodiment of the phonogram comprising the letter “f” is pronounced similar to the letter “f” as in fish. The first embodiment of the phonogram comprising the letter “f” may therefore be used to depict the letter “f” in the word “five” as the letter “f” in the word “five” is pronounced in a similar manner to the letter “f” in the word “fish”.

In a second example, the letter “f” is provided with a visual indicum in the form of a drawing of a vacuum suction nozzle and bag to form a first embodiment of a phonogram comprising the letter “f”. In this embodiment, the letter “f” and the drawing of the vacuum suction nozzle and bag fuse to form a drawing of a vacuum. The use of the known pronunciation of the word “vacuum” directly guides how the second embodiment of the phonogram comprising the letter “f” is pronounced. More particularly, the second embodiment of the phonogram comprising the letter “f” is pronounced similar to the letter “v” as in vacuum. The second embodiment of the phonogram comprising the letter “f” may therefore be used to depict the letter “f” in the word “of” as the letter “f” in the word “of” is pronounced in a similar manner to the letter “v” in the word “vacuum”.

The letter “g” may be provided with at least two different visual indicium. In a first example, the letter “g” is provided with a visual indicium in the form of color of the letter “g” itself, namely gold, to form a first embodiment of a phonogram comprising the letter “g”. The color of the letter “g” symbolizes the known word “gold”. The use of the known pronunciation of the word “gold” directly guides how the first embodiment of the phonogram comprising the letter “g” is pronounced. More particularly, the first embodiment of the phonogram comprising the letter “g” is pronounced similar to the letter “g” as in gold. The first embodiment of the phonogram comprising the letter “g” may therefore be used to depict the letter “g” in the word “get” as the letter “g” in the word “get” is pronounced in a similar manner to the letter “g” in the word “gold”.

In a second example, the letter “g” is provided with a visual indicium in the form of a drawing of jellybeans to form a second embodiment of a phonogram comprising the letter “g”. The drawing symbolizes the known word “jellybeans”. The use of the known pronunciation of the word “jellybeans” directly guides how the second embodiment of the phonogram comprising the letter “g” is pronounced. More particularly, the second embodiment of the phonogram comprising the letter “g” is pronounced similar to the letter “j” as in jellybeans. The second embodiment of the phonogram comprising the letter “g” may therefore be used to depict the letter “g” in the word “giant” as the letter “g” in the word “giant” is pronounced in a similar manner to the letter “j” in the word “jellybeans”.

The letter “h” is provided with a visual indicium in the form of a drawing of heart to form a phonogram comprising the letter “h”. The drawing symbolizes the known word “heart”. The use of the known pronunciation of the word “heart” directly guides how the second embodiment of the phonogram comprising the letter “h” is pronounced. More particularly, the phonogram comprising the letter “h” is pronounced similar to the letters “he” as in heart. The phonogram comprising the letter “h” may therefore be used to depict the letter “h” in the word “hat” as the letter “h” in the word “hat” is pronounced in a similar manner to the letter “he” in the word “heart”.

The letter “i” may be provided with at least three different visual indicium. In a first example, the letter “i” is provided with a visual indicium in the form of a drawing of an Easter egg to form a first embodiment of a phonogram comprising the letter “i”. The drawing symbolizes the known word “Easter egg”. The use of the known pronunciation of the word “Easter egg” directly guides how the first embodiment of the phonogram comprising the letter “i” is pronounced. More particularly, the first embodiment of the phonogram comprising the letter “i” is pronounced similar to the letters “ea” as in Easter egg. The first embodiment of the phonogram comprising the letter “i” may therefore be used to depict the letter “i” in the word “sing” as the letter “i” in the word “sing” is pronounced in a similar manner to the letters “ea” in word “Easter egg”.

In a second example, the letter “i” is provided with a visual indicium in the form of a drawing of an eye to form a second embodiment of a phonogram comprising the letter “i”. The drawing symbolizes the known word “eye”. The use of the known pronunciation of the word “eye” directly guides how the second embodiment of the phonogram comprising the letter “i” is pronounced. More particularly, the second embodiment of the phonogram comprising the letter “i” is pronounced similar to the letters “eye” as in eye. The second embodiment of the phonogram comprising the letter “i” may therefore be used to depict the letter “i” in the word “hide” as the letter “i” in the word “hide” is pronounced in a similar manner to the letters “eye” in the word “eye”.

In a third example, the letter “i” is provided with a visual indicium in the form of a drawing of a scratching hand to form a third embodiment of a phonogram comprising the letter “i”. The drawing symbolizes the known word “itchy”. The use of the known pronunciation of the word “itchy” directly guides how the third embodiment of the phonogram comprising the letter “i” is pronounced. More particularly, the third embodiment of the phonogram comprising the letter “i” is pronounced similar to the letter “i” as in itchy. The third embodiment of the phonogram comprising the letter “i” may therefore be used to depict the letter “i” in the word “i” as the letter “i” in the word “i” is pronounced in a similar manner to the letter “i” in the word “itchy”.

The letter “j” may be provided with at least two different visual indicium. In a first example, the letter “j” is provided with a visual indicium in the form of a drawing of jellybeans to form a first embodiment of a phonogram comprising the letter “j”. The drawing symbolizes the known word “jellybeans”. The use of the known pronunciation of the word “jellybeans” directly guides how the first embodiment of the phonogram comprising the letter “j” is pronounced. More particularly, the first embodiment of the phonogram comprising the letter “j” is pronounced similar to the letter “j” as in jellybeans. The first embodiment of the phonogram comprising the letter “j” may therefore be used to depict the letter “j” in the word “jam” as the letter “j” in the word “jam” is pronounced in a similar manner to the letter “j” in the word “jellybeans”.

In a second example, the letter “j” is provided with a visual indicium in the form of a drawing of heart to form a phonogram comprising the letter “j”. The drawing symbolizes the known word “heart”. The use of the known pronunciation of the word “heart” directly guides how the second embodiment of the phonogram comprising the letter “j” is pronounced. More particularly, the phonogram comprising the letter “j” is pronounced similar to the letters “he” as in heart.

The letter “k” is provided with a visual indicium in the form of a drawing of a cookie to form a phonogram comprising the letter “k”. The drawing symbolizes the known word “cookie”. The use of the known pronunciation of the word “cookie” directly guides how the phonogram comprising the letter “k” is pronounced. More particularly, the phonogram comprising the letter “k” is pronounced similar to the letter “c” as in cookie. The phonogram comprising the letter “k” may therefore be used to depict the letter “k” in the word “kick” as the letter “k” in the word “kick” is pronounced in a similar manner to the letter “c” in the word “cookie”.

The letter “l” is provided with a visual indicium in the form of a drawing of licorice to form a phonogram comprising the letter “l”. In this example, the letter “l” and the drawing of the licorice fuse to form a drawing of a stick of licorice. The drawing symbolizes the known word “licorice”. The use of the known pronunciation of the word “licorice” directly guides how the phonogram comprising the letter “l” is pronounced. More particularly, the phonogram comprising the letter “l” is pronounced similar to the letter “l” as in licorice. The phonogram comprising the letter “l” may therefore be used to depict the letter “l” in the word “leg” as the letter “l” in the word “leg” is pronounced in a similar manner to the letter “l” in the word “licorice”.

The letter “m” is provided with a visual indicium in the form of a drawing of monkey eyes and ears to form a phonogram comprising the letter “m”. In this example, the letter “m” and the drawing of the monkey eyes and ears fuse to form a drawing of a monkey's face. The drawing symbolizes the known word monkey. The use of the known pronunciation of the word “monkey” directly guides how the phonogram comprising the letter “m” is pronounced. More particularly, the phonogram comprising the letter “m” is pronounced similar to the letter “m” as in monkey. The phonogram comprising the letter “m” may therefore be used to depict the letter “m” in the word “mother” as the letter “m” in the word “mother” is pronounced in a similar manner to the letter “m” in the word “monkey”.

The letter “n” is provided with a visual indicium in the form of a drawing of a nets to form a phonogram comprising the letter “n”. The drawing symbolizes the known word “net.” The use of the known pronunciation of the word “net” directly guides how the phonogram comprising the letter “n” is pronounced. More particularly, the phonogram comprising the letter “n” is pronounced similar to the letter “n” as in net. The phonogram comprising the letter “n” may therefore be used to depict the letter “n” in the word “not” as the letter “n” in the word “not” is pronounced in a similar manner to the letter “n” in the word “net”.

The letter “o” may be provided with at least six different visual indicium. In a first example, the letter “o” is provided with a visual indicum in the form of a drawing of an octopus to form a first embodiment of a phonogram comprising the letter “o”. The drawing symbolizes the known word “octopus”. The use of the known pronunciation of the word “octopus” directly guides how the first embodiment of the phonogram comprising the letter “o” is pronounced. More particularly, the first embodiment of the phonogram comprising the letter “o” is pronounced similar to the letter “o” as in octopus. The first embodiment of the phonogram comprising the letter “o” may therefore be used to depict the letter “o” in the word “got” as the letter “o” in the word “got” is pronounced in a similar manner to the letter “o” in the word “octopus”.

In a second example, the letter “o” is provided with a visual indicium in the form of a drawing of the ocean to form a second embodiment of a phonogram comprising the letter “o”. The drawing symbolizes the known word “ocean”. The use of the known pronunciation of the word “ocean” directly guides how the second embodiment of the phonogram comprising the letter “o” is pronounced. More particularly, the second embodiment of the phonogram comprising the letter “o” is pronounced similar to the letter “o” as in ocean. The second embodiment of the phonogram comprising the letter “o” may therefore be used to depict the letter “o” in the word “go” as the letter “o” in the word “go” is pronounced in a similar manner to the letter “o” in the word “ocean”.

In a third example, the letter “o” is provided with a visual indicium in the form of a drawing of an umbrella to form a third embodiment of a phonogram comprising the letter “o”. The drawing symbolizes the known word “umbrella”. The use of the known pronunciation of the word “umbrella” directly guides how the third embodiment of the phonogram comprising the letter “o” is pronounced. More particularly, the third embodiment of the phonogram comprising the letter “o” is pronounced similar to the letter “u” as in umbrella. The third embodiment of the phonogram comprising the letter “o” may therefore be used to depict the letter “o” in the word “about” as the letter “o” in the word “come” is pronounced in a similar manner to the letter “u” in the word “umbrella”.

In a fourth example, the letter “o” is provided with two visual indicium to form a fourth embodiment of a phonogram comprising the letter “u”. The first visual indicium provided on the letter “o” is the color of the letter “o” itself, namely white. The color of the letter “o” symbolizes known word “white”. The second visual indicium provided on the letter “o” is a drawing in the form of wings. The drawing symbolizes the known word “wings”. The use of the known pronunciation of the words “white” and “wings” directly guide how the phonogram comprising the letter “o” is pronounced. The fourth embodiment of the phonogram comprising the letter “o” is pronounced similar to the letters “wh” as in white or the letter “w” as in wings. The fourth embodiment of the phonogram comprising the letter “o” may therefore be used to depict the letter “o” in the word “one” as the letter “o” in the word “one” is pronounced in a similar manner to the letters “wh” as in the word “white” or the letter “w” as in the word wings. The use of more than one visual indicium re-enforces the pronunciation of the fourth embodiment of the phonogram comprising the letter “o” by providing more than one known word to guide pronunciation of this phonogram.

In a fifth example, the letter “o” is provided with a visual indicium in the form of a drawing of a hula hoop to form a fifth embodiment of a phonogram comprising the letter “o”. The drawing symbolizes the known word “hula-hoop”. The use of the known pronunciation of the word “hula-hoop” directly guides how the fifth embodiment of the phonogram comprising the letter “o” is pronounced. More particularly, the fifth embodiment of the phonogram comprising the letter “o” is pronounced similar to the letters “hu” as in hula hoop. The fifth embodiment of the phonogram comprising the letter “o” may therefore be used to depict the letter “o” in the word “to” as the letter “o” in the word “to” is pronounced in a similar manner to the letters “hu” in the word “hula-hoop”.

The letter “p” is provided with two visual indicium to form a phonogram comprising the letter “p”. The first visual indicium provided on the letter “p” is the color of the letter “p” itself, namely purple. The color of the letter “p” symbolizes known word “purple”. The second visual indicium provided on the letter “p” is a drawing in the form of a pizza. The drawing symbolizes the known word “pizza”. The use of the known pronunciation of the words “purple” and “pizza” directly guide how the phonogram comprising the letter “p” is pronounced. The phonogram comprising the letter “p” is pronounced similar to the letter “p” as in purple or the letter “p” as in pizza. The phonogram comprising the letter “p” may therefore be used to depict the letter “p” in the word “pig” as the letter “p” in the word “pig” is pronounced in a similar manner to the letter “p” as in purple or the letter “p” as in pizza. The use of more than one visual indicium re-enforces the pronunciation of the phonogram comprising the letter “p” by providing more than one known word to guide pronunciation of this phonogram.

The letter “q” is provided with a visual indicium in the form of a drawing of a cookie to form a phonogram comprising the letter “q”. The drawing symbolizes the known word “cookie”. The use of the known pronunciation of the word “cookie” directly guides how the first embodiment of the phonogram comprising the letter “q” is pronounced. More particularly, the phonogram comprising the letter “q” is pronounced similar to the letter “c” as in cookie. The phonogram comprising the letter “q” may therefore be used to depict the letter “q” in the word “quack” as the letter “q” in the word “quack” is pronounced in a similar manner to the letter “c” in the word “cookie”.

The letter “r” is provided with a visual indicium in the form of color of the letter “r” itself, namely red, to form a phonogram comprising the letter “r”. The color of the letter “r” symbolizes known word “red”. The use of the known pronunciation of the word “red” directly guides how the phonogram comprising the letter “r” is pronounced. More particularly, the phonogram comprising the letter “r” is pronounced similar to the letter “r” as in red. The phonogram comprising the letter “r” may therefore be used to depict the letter “r” in the word “ran” as the letter “r” in the word “ran” is pronounced in a similar manner to the letter “r” in the word “red”.

The letter “s” may be provided with at least two different visual indicium. In a first example, the letter “s” is provided with a visual indicium in the form of a drawing of a zipper to form a first embodiment of a phonogram comprising the letter “s”. The drawing symbolizes the known word “zipper”. The use of the known pronunciation of the word “zipper” directly guides how the first embodiment of the phonogram comprising the letter “s” is pronounced. More particularly, the first embodiment of the phonogram comprising the letter “s” is pronounced similar to the letter “z” as in zipper. The first embodiment of the phonogram comprising the letter “s” may therefore be used to depict the letter “s” in the word “yours” as the letter “s” in the word “yours” is pronounced in a similar manner to the letter “z” in the word “zipper”.

In a second example, the letter “s” is provided with a visual indicium in the form of color of the letter “s” itself, namely silver, to form a second embodiment of a phonogram comprising the letter “s”. The color of the letter “s” symbolizes the known word “silver”. The use of the known pronunciation of the word “silver” directly guides how the second embodiment of the phonogram comprising the letter “s” is pronounced. More particularly, the second embodiment of the phonogram comprising the letter “s” is pronounced similar to the letter “s” as in silver. The second embodiment of the phonogram comprising the letter “s” may therefore be used to depict the letter “s” in the word “sat” as the letter “s” in the word “sat” is pronounced in a similar manner to the letter “s” in the word “silver”.

The letter “t” is provided with a visual indicium in the form of a drawing of a toothbrush to form a phonogram comprising the letter “t”. The drawing symbolizes the known word “toothbrush”. The use of the known pronunciation of the word “toothbrush” directly guides how the phonogram comprising the letter “t” is pronounced. More particularly, the phonogram comprising the letter “t” is pronounced similar to the letter “t” as in toothbrush. The phonogram comprising the letter “t” may therefore be used to depict the letter “t” in the word “top” as the letter “t” in the word “top” is pronounced in a similar manner to the letter “t” in the word “toothbrush”.

The letter “u” may be provided with at least five different visual indicium. In a first example, the letter “u” is provided with a visual indicum in the form of a drawing of a hook to form a first embodiment of a phonogram comprising the letter “u”. The drawing symbolizes the known word “hook”. The use of the known pronunciation of the word “hook” directly guides how the first embodiment of the phonogram comprising the letter “u” is pronounced. More particularly, the first embodiment of the phonogram comprising the letter “u” is pronounced similar to the letters “oo” as in hook. The first embodiment of the phonogram comprising the letter “u” may therefore be used to depict the letter “u” in the word “put” as the letter “u” in the word “put” is pronounced in a similar manner to the letters “oo” in the word “hook”.

In a second example, the letter “u” is provided with a visual indicium in the form of a drawing of the unicorn to form a second embodiment of a phonogram comprising the letter “u”. The drawing symbolizes the known word “unicorn”. The use of the known pronunciation of the word “unicorn” directly guides how the second embodiment of the phonogram comprising the letter “u” is pronounced. More particularly, the second embodiment of the phonogram comprising the letter “u” is pronounced similar to the letter “u” as in unicorn. The second embodiment of the phonogram comprising the letter “u” may therefore be used to depict the letter “u” in the word “use” as the letter “u” in the word “use” is pronounced in a similar manner to the letter “u” in the word “unicorn”.

In a third example, the letter “u” is provided with a visual indicium in the form of a drawing of an umbrella to form a third embodiment of a phonogram comprising the letter “u”. The drawing symbolizes the known word “umbrella”. The use of the known pronunciation of the word “umbrella” directly guides how the third embodiment of the phonogram comprising the letter “u” is pronounced. More particularly, the third embodiment of the phonogram comprising the letter “u” is pronounced similar to the letter “u” as in umbrella. The third embodiment of the phonogram comprising the letter “u” may therefore be used to depict the letter “u” in the word “up” as the letter “u” in the word “up” is pronounced in a similar manner to the letter “u” in the word “umbrella”.

In a fourth example, the letter “u” is provided with two visual indicium to form a fourth embodiment of a phonogram comprising the letter “u”. The first visual indicium provided on the letter “u” is the color of the letter “u” itself, namely white. The color of the letter “u” symbolizes the known word “white”. The second visual indicium provided on the letter “u” is a drawing in the form of wings. The drawing symbolizes the known word “wings”. The use of the known pronunciation of the words “white” and “wings” directly guide how the fourth embodiment of the phonogram comprising the letter “u” is pronounced. The fourth embodiment of the phonogram comprising the letter “u” is pronounced similar to the letters “wh” as in white or the letter “w” as in wings. The fourth embodiment of the phonogram comprising the letter “u” may therefore be used to depict the letter “u” in the word “quiet” as the letter “u” in the word “quiet” is pronounced in a similar manner to the letters “wh” as in the word “white” or the letter “w” as in the word wings. The use of more than one visual indicium re-enforces the pronunciation of the fourth embodiment of the phonogram comprising the letter “u” by providing more than one known word to guide the pronunciation of this phonogram.

The letter “v” is provided with a visual indicum in the form of a drawing of a vacuum suction nozzle and bag to form a phonogram comprising the letter “v”. In this example, the letter “v” and the drawing of the vacuum suction nozzle and bag fuse to form a drawing of a vacuum. The use of the known pronunciation of the word “vacuum” directly guides how the phonogram comprising the letter “v” is pronounced. More particularly, the phonogram comprising the letter “v” is pronounced similar to the letter “v” as in vacuum. The phonogram comprising the letter “v” may therefore be used to depict the letter “v” in the word “vet” as the letter “v” in the word “vet” is pronounced in a similar manner to the letter “v” in the word “vacuum”.

The letter “w” is provided with two visual indicium to form a phonogram comprising the letter “w”. The first visual indicium provided on the letter “w” is the color of the letter “w” itself, namely white. The color of the letter “wu” symbolizes known word “white”. The second visual indicium provided on the letter “w” is a drawing in the form of wings. The drawing symbolizes the known word “wings”. The use of the known pronunciation of the words “white” and “wings” directly guide how the phonogram comprising the letter “w” is pronounced. The phonogram comprising the letter “w” is pronounced similar to the letters “wh” as in white or the letter “w” as in wings. The phonogram comprising the letter “w” may therefore be used to depict the letter “w” in the word “was” as the letter “w” in the word “was” is pronounced in a similar manner to the letters “wh” as in the word “white” or the letter “w” as in the word wings. The use of more than one visual indicium re-enforces the pronunciation of the phonogram comprising the letter “w” by providing more than one known word to guide the pronunciation of this phonogram.

The letter “x” may be provided with at least three different visual indicium. In a first example, the letter “x” is provided with a visual indicium in the form of a drawing of a zipper to form a first embodiment of a phonogram comprising the letter “x”. The drawing symbolizes the known word “zipper”. The use of the known pronunciation of the word “zipper” directly guides how the first embodiment of the phonogram comprising the letter “x” is pronounced. More particularly, the first embodiment of the phonogram comprising the letter “x” is pronounced similar to the letter “z” as in zipper. The first embodiment of the phonogram comprising the letter “x” may therefore be used to depict the letter “x” in the word “xylophone” as the letter “x” in the word “xylophone” is pronounced in a similar manner to the letter “z” in the word “zipper”.

In a second example, the letter “x” is provided with two visual indicium to form a second embodiment of the phonogram comprising the letter “x”. The first visual indicium provided on the letter “x” is a drawing of a cookie. The drawing symbolizes the known word “cookie”. The second visual indicium is the color of the letter “x” itself, namely silver. The color of the letter “c” symbolizes the known word “silver”. The use of the known pronunciation of the words “cookie” and “silver” directly guide how the second embodiment of the phonogram comprising the letter “x” is pronounced. The second embodiment of the phonogram comprising the letter “x” is pronounced similar to a combination the letter “c” as in cookie and the letter “s” as in silver. The second embodiment of the phonogram comprising the letter “x” may therefore be used to depict the letter “x” in the word “box” as the letter “x” in the word “box” is pronounced in a similar manner to the combination of the letter “c” as in the word “cookie” together with the letter “s” as in the word silver. The use of two or cooperating visual indicium allows for the provision of phonograms which have unique pronunciations which are similar to a combination of sounds.

The letter “y” may be provided with at least four different visual indicium. In a first example, the letter “y” is provided with a visual indicium in the form of a drawing of an Easter egg to form a first embodiment of a phonogram comprising the letter “y”. The drawing symbolizes the known word “Easter egg”. The use of the known pronunciation of the word “Easter egg” directly guides how the first embodiment of the phonogram comprising the letter “y” is pronounced. More particularly, the first embodiment of the phonogram comprising the letter “y” is pronounced similar to the letters “ea” as in Easter egg. The first embodiment of the phonogram comprising the letter “i” may therefore be used to depict the letter “y” in the word “happy” as the letter “y” in the word “happy” is pronounced in a similar manner to the letters “ea” in the word “Easter egg”.

In a second example, the letter “y” is provided with a visual indicium in the form of a drawing of an eye to form a second embodiment of a phonogram comprising the letter “y”. The drawing symbolizes the known word “eye”. The use of the known pronunciation of the word “eye” directly guides how the second embodiment of the phonogram comprising the letter “y” is pronounced. More particularly, the second embodiment of the phonogram comprising the letter “y” is pronounced similar to the letters “eye” as in eye. The second embodiment of the phonogram comprising the letter “y” may therefore be used to depict the letter “y” in the word “my” as the letter “y” in the word “my” is pronounced in a similar manner to the letters “eye” in the word “eye”.

In a third example, the letter “y” is provided with a visual indicium in the form of a drawing of a scratching hand to form a third embodiment of a phonogram comprising the letter “y”. The drawing symbolizes the known word “itchy”. The use of the known pronunciation of the word “itchy” directly guides how the third embodiment of the phonogram comprising the letter “y” is pronounced. More particularly, the third embodiment of the phonogram comprising the letter “y” is pronounced similar to the letter “i” as in itchy. The third embodiment of the phonogram comprising the letter “y” may therefore be used to depict the letter “y” in the word “gym” as the letter “y” in the word “gym” is pronounced in a similar manner to the letter “i” in the word “itchy”.

In a fourth example, the letter “y” is provided with a visual indicium in the form of color of the letter “y” itself, namely yellow, to form a fourth embodiment of a phonogram comprising the letter “y”. The color of the letter “y” symbolizes the known word “yellow”. The use of the known pronunciation of the word “yellow” directly guides how the fourth embodiment of the phonogram comprising the letter “y” is pronounced. More particularly, the fourth embodiment of the phonogram comprising the letter “y” is pronounced similar to the letter “y” as in yellow. The fourth embodiment of the phonogram comprising the letter “y” may therefore be used to depict the letter “y” in the word “yes” as the letter “y” in the word “yes” is pronounced in a similar manner to the letter “y” in the word “yellow”.

The letter “z” is provided a visual indicium in the form of a drawing of a zipper to form a phonogram comprising the letter “z”. The drawing symbolizes the known word “zipper”. The use of the known pronunciation of the word “zipper” directly guides how the phonogram comprising the letter “z” is pronounced. More particularly, the first embodiment of the phonogram comprising the letter “z” is pronounced similar to the letter “z” as in zipper. The phonogram comprising the letter “z” may therefore be used to depict the letter “z” in the word “zebra” as the letter “z” in the word “zebra” is pronounced in a similar manner to the letter “z” in the word “zipper”.

From the examples shown in FIG. 1, it will be understood by a person skilled in the art that when the same visual indicia are provided to different alphabet letters, the resulting phonogram are pronounced in the same way, i.e. the phonogram comprised of the letter “c” and a visual indicium in the form of a drawing of a cookie is pronounced in the same way as the phonogram comprised of the letter “k” and a visual indicium in the form of a drawing of a cookie, and the phonogram comprised of the letter “q” and a visual indicium in the form of a drawing of a cookie. It will also be understood by a person skilled in the art that the phonograms shown in FIG. 1 are given by way of example only and are not intended to limited the scope of the phonograms which may be used to practice the method of teaching reading disclosed herein.

As shown in FIG. 2, the letter group “al” is provided with a visual indicia in the form of a of a drawing of an alligator to form a phonogram comprising the letter group “al”. The drawing symbolizes the known word “alligator”. The use of the known pronunciation of the word “alligator” directly guides how this phonogram comprising the letter group “al” is pronounced. More particularly, this phonogram comprising the letter group “al” is pronounced similar to the letters “all” as in alligator. This phonogram comprising the letter group “al” may therefore be used to depict the letters “al” in the word “gal” as the letters “al” in the word “gal” are pronounced in a similar manner to the letters “all” in word “alligator”.

The letter group “an” is provided with a visual indicia in the form of a of a drawing of an ant to form a phonogram comprising the letter group “an”. The drawing symbolizes the known word “ant”. The use of the known pronunciation of the word “ant” directly guides how this phonogram comprising the letter group “an” is pronounced. More particularly, this phonogram comprising the letter group “an” is pronounced similar to the letters “an” as in ant. This phonogram comprising the letter group “an” may therefore be used to depict the letters “an” in the word “van” as the letters “an” in the word “van” are pronounced in a similar manner to the letters “an” in word “ant”.

The letter group “ar” is provided with two visual indicia to form a phonogram comprising the letter group “ar”. The first visual indicium is a drawing of an arm. The drawing symbolizes the known word “arm”. The second indicium is an arrow pointing to the letter “r”. The use of the known pronunciation of the word “arm” directly guides how this phonogram comprising the letter group “ar” is pronounced. More particularly, this phonogram comprising the letter group “ar” is pronounced similar to the letters “ar” as in arm. This phonogram comprising the letter group “ar” may therefore be used to depict the letters “ar” in the word “car” as the letters “ar” in the word “car” are pronounced in a similar manner to the letters “ar” in the word “arm”. The second visual indicia guides the pronunciation of the letter group “ar” by indicating an emphasis on the letter “r”.

The letter group “ch” is provided with a visual indicia in the form of a drawing of a chair to form a phonogram comprising the letter group “ch”. The drawing symbolizes the known word “chair”. The use of the known pronunciation of the word “chair” directly guides how this phonogram comprising the letter group “ch” is pronounced. More particularly, this phonogram comprising the letter group “ch” is pronounced similar to the letters “ch” as in chair. This phonogram comprising the letter group “ch” may therefore be used to depict the letters “ch” in the word “chip” as the letters “ch” in the word “chip” are pronounced in a similar manner to the letters “ch” in the word “chair”.

The letter group “el” is provided with two visual indicia to form a phonogram comprising the letter group “el”. The first visual indicium is a drawing of an elephant. The drawing symbolizes the known word “elephant”. The second indicium is an arrow pointing to the letter “l”. This use of the known pronunciation of the word “elephant” directly guides how this phonogram comprising the letter group “el” is pronounced. More particularly, this phonogram comprising the letter group “el” is pronounced similar to the letters “el” as in elephant. This phonogram comprising the letter group “el” may therefore be used to depict the letters “el” in the word “gel” as the letters “el” in the word “gel” are pronounced in a similar manner to the letters “el” in the word “elephant”. The second visual indicia guides the pronunciation of the letter group “el” by indicating an emphasis on the letter “l”.

The letter group “ff” is provided with a visual indicia in the form of a drawing of a fish to form a phonogram comprising the letter group “ff” . The drawing symbolizes the known word “fish”. The use of the known pronunciation of the word “fish” directly guides how this phonogram comprising the letter group “ff” is pronounced. More particularly, this phonogram comprising the letter group “ff” is pronounced similar to the letter “f” as in fish. This phonogram comprising the letter group “ff” may therefore be used to depict the letters “ff” in the word “cuff” as the letters “ff” in the word “cuff” are pronounced in a similar manner to the letter “f” in the word “fish”.

The letter group “gh” is provided with a visual indicia in the form of a drawing of a fish to form a phonogram comprising the letter group “gh”. The drawing symbolizes the known word “fish”. The use of the known pronunciation of the word “fish” directly guides how this phonogram comprising the letter group “gh” is pronounced. More particularly, this phonogram comprising the letter group “gh” is pronounced similar to the letter “f” as in fish. This phonogram comprising the letter group “gh” may therefore be used to depict the letters “gh” in the word “cough” as the letters “ff” in the word “cough” are pronounced in a similar manner to the letter “f” in the word “fish”.

The letter group “ph” is provided with a visual indicia in the form of a drawing of a fish to form a phonogram comprising the letter group “ph”. The drawing symbolizes the known word “fish”. The use of the known pronunciation of the word “fish” directly guides how this phonogram comprising the letter group “ph” is pronounced. More particularly, this phonogram comprising the letter group “ph” is pronounced similar to the letter “f” as in fish. This phonogram comprising the letter group “ph” may therefore be used to depict the letters “ph” in the word “phone” as the letters “ph” in the word “phone” are pronounced in a similar manner to the letter “f” in the word “fish”.

The letter group “oo” is provided with a visual indicia in the form of a drawing of hook to form a phonogram comprising the letter group “oo”. The drawing symbolizes the known word “hook”. The use of the known pronunciation of the word “hook” directly guides how this phonogram comprising the letter group “oo” is pronounced. More particularly, this phonogram comprising the letter group “oo” is pronounced similar to the letters “oo“as in hook. This phonogram comprising the letter group “oo” may therefore be used to depict the letters “oo” in the word “look” as the letters “oo” in the word “look” are pronounced in a similar manner to the letters “oo” in the word “hook”.

The letter group “aw” is provided with a visual indicium in the form of a drawing of an octopus to form a phonogram comprising the letter “aw”. The drawing symbolizes the known word “octopus”. The use of the known pronunciation of the word “octopus” directly guides how this phonogram comprising the letter group “aw” is pronounced. More particularly, this phonogram comprising the letter group “aw” is pronounced similar to the letter “o” as in octopus. This phonogram comprising the letter group “aw” may therefore be used to depict the letters “aw” in the word “saw” as the letters “aw” in the word “saw” is pronounced in a similar manner to the letter “o” in the word “octopus”.

The letter group “au” is provided with a visual indicium in the form of a drawing of an octopus to form a phonogram comprising the letter “au”. The drawing symbolizes the known word “octopus”. The use of the known pronunciation of the word “octopus” directly guides how this phonogram comprising the letter group “au” is pronounced. More particularly, this phonogram comprising the letter group “au” is pronounced similar to the letter “o” as in octopus. This phonogram comprising the letter group “au” may therefore be used to depict the letters “au” in the word “because” as the letters “au” in the word “because” is pronounced in a similar manner to the letter “o” in the word “octopus”.

The letter group “ou” is provided with a visual indicium in the form of a drawing of an octopus to form a phonogram comprising the letter “ou”. The drawing symbolizes the known word “octopus”. The use of the known pronunciation of the word “octopus” directly guides how this phonogram comprising the letter group “ou” is pronounced. More particularly, this phonogram comprising the letter group “ou” is pronounced similar to the letter “o” as in octopus. This phonogram comprising the letter group “ou” may therefore be used to depict the letters “ou” in the word “cough” as the letters “ou” in the word “cough” is pronounced in a similar manner to the letter “o” in the word “octopus”.

The letter group “al” is provided with a visual indicium in the form of a drawing of an octopus to form a phonogram comprising the letter “al”. The drawing symbolizes the known word “octopus”. The use of the known pronunciation of the word “octopus” directly guides how this phonogram comprising the letter group “al” is pronounced. More particularly, this phonogram comprising the letter group “al” is pronounced similar to the letter “o” as in octopus. This phonogram comprising the letter group “al” may therefore be used to depict the letters “al” in the word “walk” as the letters “al” in the word “walk” is pronounced in a similar manner to the letter “o” in the word “octopus”.

The letter group “sh” is provided with a visual indicium in the form of a drawing of a shadow to form a phonogram comprising the letter “sh”. The drawing symbolizes the known word “shadow”. The use of the known pronunciation of the word “shadow” directly guides how this phonogram comprising the letter group “sh” is pronounced. More particularly, this phonogram comprising the letter group “sh” is pronounced similar to the letters “sh” as in shadow. This phonogram comprising the letter group “sh” may therefore be used to depict the letters “sh” in the word “shoe” as the letters “sh” in the word “shoe” are pronounced in a similar manner to the letters “sh” in the word “shadow”.

The letter group “ti” is provided with a visual indicium in the form of a drawing of a shadow to form a phonogram comprising the letter “ti”. The drawing symbolizes the known word “shadow”. The use of the known pronunciation of the word “shadow” directly guides how this phonogram comprising the letter group “ti” is pronounced. More particularly, this phonogram comprising the letter group “ti” is pronounced similar to the letters “sh” as in shadow. This phonogram comprising the letter group “ti” may therefore be used to depict the letters “ti” in the word “fraction” as the letters “ti” in the word “fraction” are pronounced in a similar manner to the letters “sh” in the word “shadow”.

The letter group “oy” is provided with a visual indicium in the form of a drawing of a boy to form a phonogram comprising the letter “oy”. The drawing symbolizes the known word “boy”. The use of the known pronunciation of the word “boy” directly guides how this phonogram comprising the letter group “oy” is pronounced. More particularly, this phonogram comprising the letter group “oy” is pronounced similar to the letters “oy” as in boa. This phonogram comprising the letter group “oy” may therefore be used to depict the letters “oy” in the word “toy” as the letters “oy” in the word “toy” are pronounced in a similar manner to the letters “oy” in the word “boy”.

The letter group “oi” is provided with a visual indicium in the form of a drawing of a boy to form a phonogram comprising the letter “oi”. The drawing symbolizes the known word “boy”. The use of the known pronunciation of the word “boy” directly guides how this phonogram comprising the letter group “oi” is pronounced. More particularly, this phonogram comprising the letter group “oi” is pronounced similar to the letters “oy” as in boy. This phonogram comprising the letter group “oi” may therefore be used to depict the letters “oi” in the word “join” as the letters “oi” in the word “join” are pronounced in a similar manner to the letters “oy” in the word “boy”.

The letter group “ing” is provided with a visual indicia in the form of the font of the letter group “ing” itself, namely italics. The italics symbolize the importance of pronouncing the letter group “ing”.

From the examples shown in FIG. 2, it will be understood by a person skilled in the art that when the same visual indicia are provided to different alphabet letter groups the resulting phonograms are pronounced the same way, i.e. the phonogram comprised of the letter group “ff” and a visual indicium in the form of a drawing of a fish is pronounced in the same way as the phonogram comprised of the letter “gh” and a visual indicium in the form of a drawing of a fish, and the phonogram comprised of the letter “ph” and a visual indicium in the form of a drawing of a fish. It will also be understood by a person skilled in the art that the phonograms shown in FIG. 2 are given by way of example only and are not intended to limited the scope of the phonograms which may be used to practice the method of teaching reading disclosed herein. Different indica and different letter groups may be combined to form phonograms as required.

In operation, letters or letter groups comprising a word to be taught are provided with visual indicium to form phonograms. FIG. 3 shows the letters “h”, “a”, and “d” which comprise the word “had” provided with visual indicium to form phonograms. The letter “h” is provided with a visual indicium in the form of a drawing of a heart. This indicates a pronunciation similar to “h” as in heart. The letter “a” is provided with a visual indicium in the form of a drawing of an apple stem and leaf fused with the letter “a”, to form a drawing of an apple. This indicates a pronunciation similar to “a” as in apple. The letter “d” is provided with a visual indicium in the form of a drawing of dots. This indicates a pronunciation similar to “d” as in dots. A student is therefore able to read the word “had”, as shown in FIG. 3, by combining the pronunciations of the above-mentioned phonograms. Since the alphabet letters are the dominant portion of each phonogram, the word “had” depicted in phonograms is substantially similar to the word “had” depicted in regular font. This facilitates the transition to reading of the word “had” depicted in regular font, once reading of the word “had” depicted in phonograms has been taught according to the method disclosed herein.

FIG. 4 shows the letter group “an” and the letter “d” comprising the word “and” provided with visual indicium to form phonograms. The letter group “an” is provided a visual indicium in the form of a drawing of an ant. This indicates a pronunciation similar to “an” as in ant. The letter “d” is provided with a visual indicium in the form of a drawing of dots. This indicates a pronunciation similar to “d” as in dots. A student is therefore able to easily read the word “and”, as shown in FIG. 4, by combining the pronunciations of the above-mentioned phonograms.

FIG. 5 shows the letters comprising the word “goes” provided with visual indicium to form phonograms. The exception being the letter “e” which is depicted in regular font. When a letter is not provided with a visual indicium this indicates that the letter is silent. In this example, the letter “g” is provided with a visual indicium in the form of the color of the letter “g” itself, namely gold. This indicates a pronunciation similar to “g” as in gold. The letter “o” is provided with a visual indicium in the form of a drawing of the ocean. This indicates a pronunciation similar to “o” as in ocean. The letter “s” is provided with visual indicium in the form of a drawing of a zipper. This indicates a pronunciation similar to “z” as in zipper. A student is therefore able to easily read the word “goes”, as shown in FIG. 5, by combining the pronunciations of the above-mentioned phonograms and disregarding any pronunciation of the letter “e” depicted in regular font.

FIG. 6 shows a first embodiment of the word “cough” in which the letter “c” and letter groups “ou” and “gh” are provided with visual indicium to form phonograms. The letter “c” is provided with a visual indicium in the form of a drawing of a cookie indicating a pronunciation similar to “c” as in cookie. The letter group “ou” is provided with a visual indicium in the form of a drawing of an octopus indicating a pronunciation similar to “o” as in octopus. The letter group “gh” is provided with a visual indicium in the form of a drawing of a fish indicating a pronunciation similar to “f” as in fish. A student is therefore able to easily read the word “cough”, as shown in FIG. 6, by combining the pronunciations of the above-mentioned phonograms.

FIG. 7 shows a second embodiment of the word “cough” in which the letters “c”, “o” and “u” are depicted in bolded font and the letter group “gh” is provided with visual indicia to form a phonogram. The letter group “gh” is provided with a visual indicium in the form of a drawing of a fish indicating a pronunciation similar to “f” as in fish. The embodiment of the word cough, shown in FIG. 7, may be used with advanced students. As a student progresses visual indicium are gradual removed from the letters or letter groups comprising the word being taught until only the more difficult parts of the word are depicted by phonograms. Students often experience difficulty learning that in certain words the letter group “gh” has a pronunciation similar to “f” as in fish. As such, in this example, the letter group “gh” is provided with a visual indicium in the form of a drawing of a fish to indicate a pronunciation similar to “f” as in fish. It will be understood that a person skilled in the art that in the embodiment of the word “cough” shown in FIG. 7 the letters letters “c”, “o” and “u” are not silent but rather an advanced student is able to sound these letters without the aid of visual indicium.

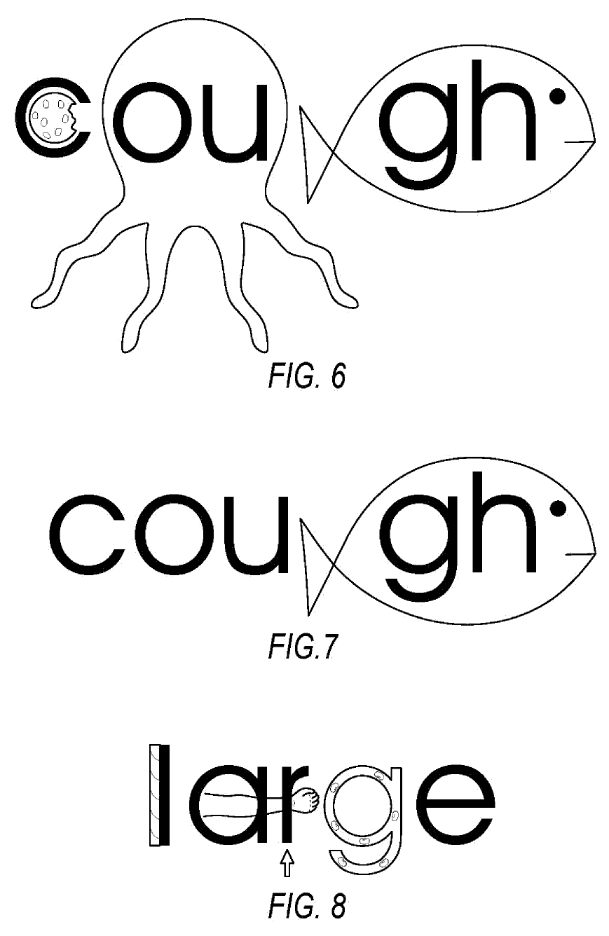

FIG. 8 shows the letters and letter groups comprising the word “large” provided with visual indicium to form phonograms. The exception being the letter “e” which is depicted in regular font. The letter “l” is provided with a visual indicium in the form of a drawing of licorice fused together with the letter “l” to form a drawing of a stick of licorice. This indicates a pronunciation similar to “l” as in licorice. The letter group “ar” is provided with two visual indicium. The first visual indicium is in the form of a drawing of an arm. This indicates a pronunciation similar to “ar” as in arm. The second visual indicium is a drawing in the form of an arrow pointing to the letter “r”. This indicates an emphasis on the pronunciation of the letter “r”. The letter “g” is provided with a visual indicium in the form of a drawing of jellybeans. This indicates a pronunciation similar to “j” as in jellybeans. The letter “e” is depicted in regular font indicating that the letter “e” is silent. A student is therefore able to easily read the word “large”, as shown in FIG. 8, by combining the pronunciations of the above-mentioned phonograms and disregarding any pronunciation the letter “e” depicted in regular font.

The method disclosed herein may also be used for teaching alphabet letters. Alphabet letters may be provided with visual indicium to create phonograms as described above. At least a portion of the pronunciation of each phonogram will sound the corresponding alphabet letter being taught. In one example, the following phonograms may be used to the teach the English alphabet:

The letter “a” may be provided with a drawing in the form of the numeral 8 to symbolize the known word “eight”. The letter “a” is pronounced similar to “eigh” as in eight.

The letter “b” may be provided with a drawing in the form of a bee to symbolize the known word “bee”. The letter “b” is pronounced similar to “bee” as in bee.

The letter “c” may be provided with a drawing in the form of a seed to symbolize the known word “seed”. The letter “c” is pronounced similar to “see” as in seed.

The letter “d” may be provided with a drawing in the form of a DVD to symbolize the known word “DVD”. The letter “d” is pronounced similar to “D” as in DVD.

The letter “e” may be provided with a drawing in the form of an Easter egg to symbolize the known word “Easter egg”. The letter “e” is pronounced similar to “ea” as in Easter egg.

The letter “f” may be provided with a drawing in the form of a chef to symbolize the known word “chef”. The letter “f” is pronounced similar to “f” as in chef

The letter “h” may be provided with drawings in the form of the numeral 8 and a chair to symbolize the known words “eight” and “chair”. The letter “h” is pronounced similar to a combination of “eigh” as in eight and “ch” as in chair.

The letter “i” may be provided with a drawing in the form of an eye to symbolize the known word “eye”. The letter “i” is pronounced similar to “eye” as in eye.

The letter “j” may be provided with a drawing in the form of a jail to symbolize the known word “jail”. The letter “j” is pronounced similar to “j” as in jail.

The letter “k” may be provided with a drawing in the form of a cake to symbolize the known word “cake”. The letter “k” is pronounced similar to “c” as in cake.

The letter “l” may be provided with a drawing in the form of an elephant to symbolize the known word “elephant”. The letter “l” is pronounced similar to “el” as in elephant.

The letter “m” may be provided with a drawing in the form of an empty bucket jail to symbolize the known word “empty bucket”. The letter “m” is pronounced similar to “em” as is in empty bucket.

The letter “n” may be provided with a drawing in the form of an envelope to symbolize the known word “envelope”. The letter “n” is pronounced similar to “en” as in envelope.

The letter “o” may be provided with a drawing in the form of the ocean to symbolize the known word “ocean”. The letter “o” is pronounced similar to “o” as in ocean.

The letter “p” may be provided in the color pink to symbolize the known word “pink”. The letter “p” is pronounced similar to “p” as in pink.

The letter “q” may be provided with a drawing in the form of a cucumber to symbolize the known word “cucumber”. The letter “q” is pronounced similar to “cu” as in cucumber.

The letter “r” may be provided with a drawing in the form of an arm to symbolize the known word “arm”. The letter “r” is pronounced similar to “r” as in arm.

The letter “s” may be provided with a drawing in the form of a dress to symbolize the known word “dress”. The letter “s” is pronounced similar to “ss” as in dress.

The letter “t” may be provided with a drawing in the form of a TV to symbolize the known word “TV”. The letter “t” is pronounced similar to “T” as in TV.

The letter “u” may be provided with a drawing in the form of a unicorn to symbolize the known word “unicorn”. The letter “u” is pronounced similar to “u” as in unicorn.

The letter “v” may be provided with a drawing in the form of a TV to symbolize the known word “TV”. The letter “v” is pronounced similar to “V” as in TV.

The letter “w” may be provided with a drawing in the form of two unicorns to symbolize the known word “unicorn”. The letter “w” is pronounced similar to double “u” as in unicorn.

The letter “x” may be provided with a drawing in the form of an exit sign to symbolize the known word “exit”. The letter “x” is pronounced similar to “ex” as in exit.

The letter “y” may be provided with a drawing in the form of a wire to symbolize the known word “wire”. The letter “y” is pronounced similar to “w” as in wire.

The letter “z” may be provided with a drawing in the form of a zebra to symbolize the known word “zebra”. The letter “z” is pronounced similar to “z” as in zebra.

It will be understood by a person skilled in the art that the method disclosed herein is not restricted to the English language but may be applied to any language which uses alphabet letters. The method may also be used for teaching a new or foreign language, writing a book, and other similar functions.

It will further be understood by someone skilled in the art that many of the details provided above are by way of example only and are not intended to limit the scope of the invention which is to be determined with reference to the following claims.

What is claimed is:

1. A method of teaching a student how to read, the method comprising:
selecting a word to be taught, the word comprising a letter;
providing the letter with a visual indicium to form a phonogram, the visual indicium symbolizing a known word having a known pronunciation;
using at least a portion of the known pronunciation of the known word to guide the student on how the phonogram is pronounced; and
using the pronunciation of the phonogram to guide the student on how the word to be taught is read.

2. The method as claimed in claim 1 wherein a first part of the known pronunciation of the known word is used to guide the student on how the phonogram is pronounced.

3. The method as claimed in claim 1 wherein the visual indicium is provided in the form of a drawing of the known word.

4. The method as claimed in claim 1 wherein the visual indicium is provided in the form of a color of the letter and the known word is a name of the color.

5. The method as claimed in claim 1 wherein the letter provided with the visual indicium is part of a letter group, the letter group including at least two letters, and the visual indicium visually links the letter to the letter group.

6. A method of a student an alphabet, the method comprising:
selecting a letter to be taught;
providing the letter with a visual indicium to form a phonogram, the visual indicium symbolizing a known word having a known pronunciation;
using at least a portion of the known pronunciation of the known word to guide the student on how the phonogram is pronounced; and
using at least a portion of the pronunciation of the phonogram to teach the student the letter to be taught.

7. The method as claimed in claim 6 wherein a first part of the known pronunciation of the known word is used to guide the student on how the phonogram is pronounced.

8. The method as claimed in claim 6 wherein the visual indicium is provided in the form of a drawing of the known word.

9. The method as claimed in claim 6 wherein the visual indicium is provided in the form of a color of the letter and the known word is a name of the color.

10. A printed document comprising a word including a phonogram, the phonogram including a letter and a visual indicium, the visual indicium symbolizing a known word having a known pronunciation, at least a portion of the known pronunciation of the known word guiding how the phonogram is pronounced, and the pronunciation of the phonogram guiding how the word is read.

11. The printed document as claimed in claim 10 wherein a first part of the known pronunciation of the known word guides how the phonogram is pronounced.

12. The printed document as claimed in claim 10 wherein the visual indicium is in the form of a drawing of the known word.

13. The printed document as claimed in claim 10 wherein the visual indicium is in the form of a color of the letter and the known word is a name of the color.

14. The printed document as claimed in claim 10 wherein the letter is the dominant part of the phonogram.
